(19) United States
(12) Patent Application Publication
(10) Pub. No.: US 2020/0300675 A1
(43) Pub. Date: Sep. 24, 2020

(54) GAUGE

(71) Applicant: NIPPON SEIKI CO., LTD., Nigata (JP)

(72) Inventor: Naoaki HAYAKAWA, Niigata (JP)

(73) Assignees: NIPPON SEIKI CO., LTD., Niigata (JP); NIPPON SEIKI CO., LTD., Niigata (JP)

(21) Appl. No.: 16/088,391

(22) PCT Filed: Apr. 13, 2017
(86) PCT No.: PCT/JP2017/015132

§ 371 Date: Sep. 25, 2018

(30) Foreign Application Priority Data
Apr. 25, 2016 (JP) 2016-087339

(51) Int. Cl. G01D 11/24; G01D 11/26

(52) U.S. Cl. CPC G01D 11/24; G01D 11/26

(57) ABSTRACT

Provided is a gauge in which it is possible to suppress reductions in external appearance due to imperfections in an anti-reflection part. This gauge is provided with: a display part for displaying a measured quantity; a translucent plate positioned on the front-surface side of the display part, the translucent plate allowing visual confirmation of the display part through the translucent plate; a clamp part for clamping an end part of the translucent plate; and an anti-reflection part provided to the display part side surface of the translucent plate the anti-reflection part having a plurality of conical protrusions arrayed at a pitch equal to or less than the wavelength of visible light. The anti-reflection part is provided away from the end part of the translucent plate, and is provided so as not to contact the clamp part.

### TECHNICAL FIELD

The present invention relates to a gauge, and in particular to a gauge provided with an anti-reflection part having fine conical protrusions.

### BACKGROUND ART

As a gauge provided with an anti-reflection part having fine conical projections, there is the one disclosed in Patent Literature 1. The gauge described in Patent Literature 1 is intended to reduce external light reflection by providing, on a rear face of a cover plate, a film having a plurality of conical protrusions disposed in pitches, each of which is equal to or shorter than a wavelength of visible light (a so called film utilizing moth's eye structure).

### CITATION LIST

### Patent Literature

Patent Literature 1: Japanese Unexamined Patent Application Publication No. 2015-78924

### SUMMARY OF THE INVENTION

### Problems to be Solved by the Invention

In the gauge described in Patent Literature 1, the film (anti-reflection part) is provided all over the rear face of the cover plate and thus the anti-reflection part comes into contact with exterior parts and then is released, or alternatively, air bubbles get into the anti-reflection part, and there is an apprehension that the appearance is degraded.

The present invention has been made in view of the circumstance described above, and it is an object of the present invention to provide a gauge which is capable of restraining degradation of an appearance exerted by a failure of an anti-reflection part.

### Solution to Problem

To achieve the above object, a gauge according to the present invention includes:

a display part that displays an amount of measurement;

a translucent plate located at a front side of the display part and causing visual recognition through the display part;

a clamp part that clamps an end part of the translucent plate; and

an anti-reflection part provided on a face at a side of the display part of the translucent plate and having a plurality of conical protrusions arrayed in pitches, each of which is equal to or less than a wavelength of visible light,

in which the anti-reflection part is provided at a position not in the end part and not in contact with the clamp part.

### Effect of the Invention

According to the present invention, degradation of an appearance due to a failure of an anti-reflection part can be avoided,

### BRIEF DESCRIPTION OF THE DRAWINGS

FIG. 1 is a view showing a gauge according to a first embodiment of the present invention, in which FIG. 1(a) is a plan view, and FIG. 1(b) is a schematic cross section taken along the line A-A shown in FIG. 1(a).

FIG. 2 is an enlarged view of portion B shown in FIG. 1(b).

FIG. 3 is an enlarged view of portion C shown in FIG. 1(b).

FIG. 4 is a view for explaining a gauge according to a second embodiment.

### MODE FOR CARRYING OUT THE INVENTION

An embodiment of the present invention will be described with reference to the drawings.

### First Embodiment

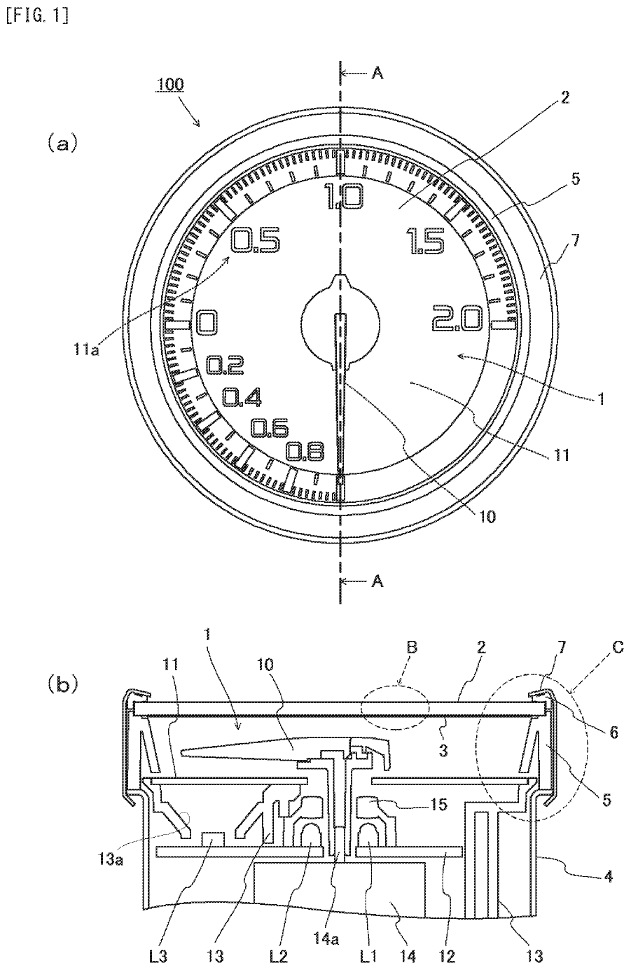

A gauge 100 according to a first embodiment, as shown in FIG. 1(a) and FIG. 1(b), is configured as an indicator-type gauge that displays an amount of measurement by an indicator 10. The gauge 100 is mounted to a vehicle for example, and displays, for a user (mainly a driver), the amounts of measurement related to the vehicle such as a vehicular speed, the number of engine rotations, or the remaining amount of fuel.

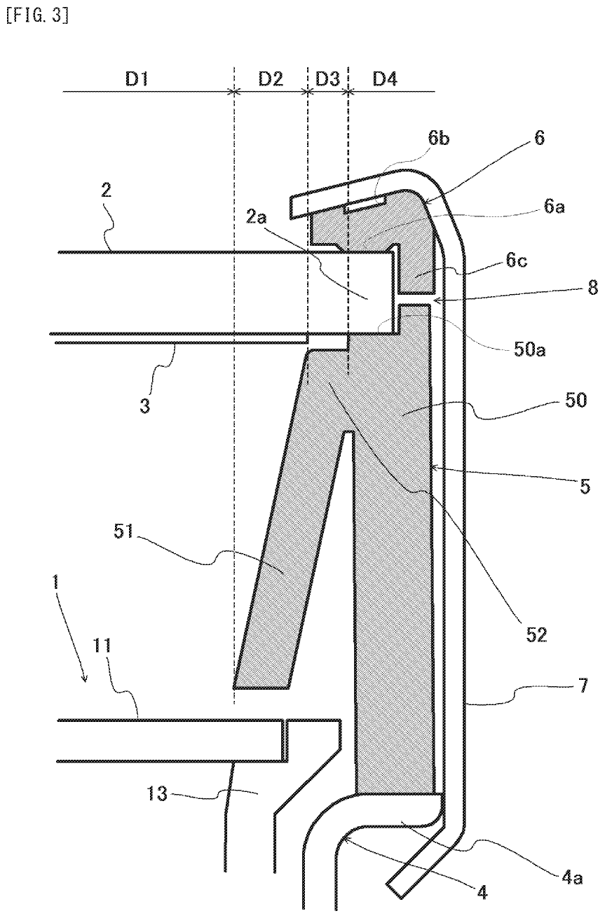

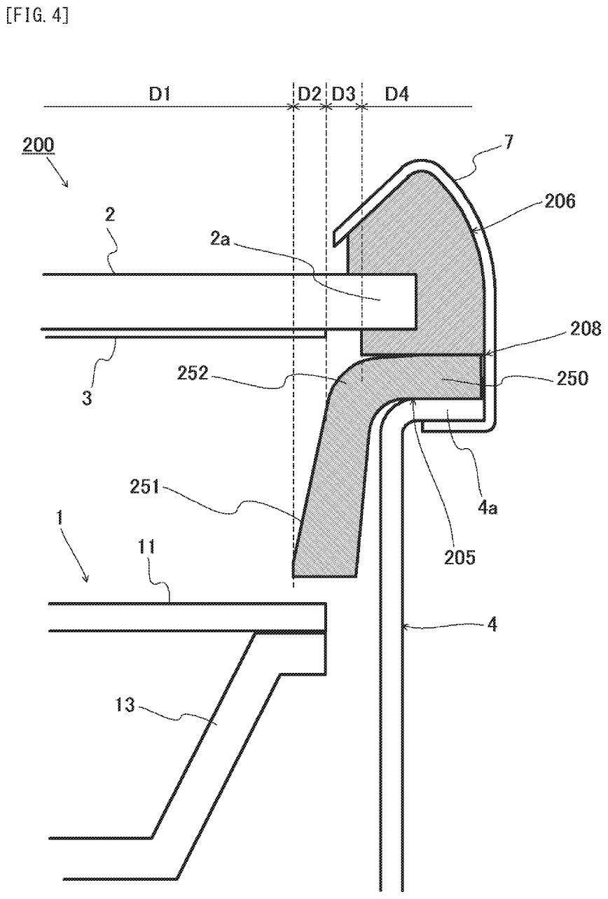

Hereinafter, for the sake of a clear understanding of the configuration, constituent elements of the gauge 100 will be appropriately described presupposing that an upper side in FIG. 1(b) showing a cross section of the gauge 100 is a “front side”, and a lower side is a “rear side”. Considering the easiness of view, hatchings indicative of the cross section in FIG. 1(a) and FIG. 3 (also FIG. 4) are appropriately omitted.

The gauge 100, as shown in FIG. 1(a) and, FIG. 1(b) to FIG. 3, is provided with a display part 1, a translucent plate 2, an anti-reflection part 3, a casing 4, a facing member 5, a packing 6, and a bezel 7.

The display part 1 displays the amount of measurement such as the vehicular speed described previously, and is provided with an indicator 10, a character plate 11, a circuit board 12, and a middle casing 13.

The indicator 10 is rotatable on a front side of the character plate 11, and indicates a pointer part 11a (refer to FIG. 1(a) formed on the character plate 11. The pointer part 11a is composed of scale, numeric values or the like. The display part 1 compares and reads the indicated part of the indicator 10 and the pointer part 11a to thereby broadcast the amount of measurement to a user. The indicator 10 is formed of a light guide member in at least a part thereof, and can emit light by receiving the light from light sources L1, L2 so as to be thereby able to emit the light. Also, the pointer part 11a is formed having light transmissibility, and can emit light by receiving the light from a character plate light source L3.

The circuit board 12 is made of a printed circuit board on which a motor 14 (for example, stepping motor) that rotationally drives the indicator 10; light sources L1, L2 illuminating the indicator 10; and a character plate light source L3 illuminate the character plate 11 or the like are implemented. A motor 14 rotates, according to the amount of measurement, the indicator 10 mounted to a rotary shaft 14a thereof.

The parts implemented on the circuit board 12 operate under the control of a control part which is not shown. The control part is composed of a microcomputer or the like, and acquires data indicative of various amounts of measurement from a variety of sensors such as a vehicular speed sensor. Based on the thus acquired data, the control part drives the motor 14, and rotates the indicator 10 by a rotation angle according to the amount of measurement such as the vehicular speed. The control part also controls lighting of the light sources L1, L2 and the character plate light source L3.

The middle casing 13 is positioned between the character plate 11 and the circuit board 12, and supports the character plate 11. The middle casing 13 is formed of predetermined resin in white, for example, and has an illumination chamber 13a that efficiently guides, to the character plate, the light emitted from the light sources L1, L2. A light guiding member 15 that guides, to the indicator 10, the light emitted from the light sources L1, L2, are provided farther toward the rotary shaft 14a side than an illumination chamber 13a.

The translucent plate 2 is made of light transmissible resin such as PMMA (polymethylmethacrylate resin), and is located on a front side of the display part 1. The translucent plate 2, as shown in FIG. 1(a), is formed in a circular shape in a planar view.

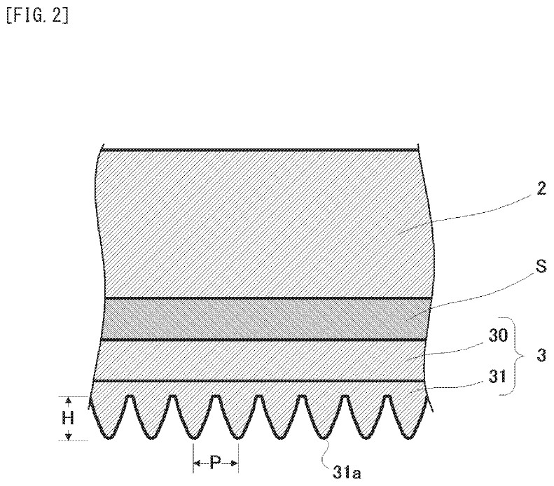

The anti-reflection part 3, as shown in an enlarged manner in FIG. 2, is a film (sheet) which is configured by an irregular layer 31 of a moth's eye structure being coated on a film-shaped substrate 30. The anti-reflection part 3 is secured to come into intimate contact with a rear face of the translucent plate 2 by way of an adhesive S having high transparency. The anti-reflection part 3 may be fused and secured to the translucent plate 2 when the translucent plate 2 is subjected to injection molding.

The anti-reflection part 3 is formed in a circular shape which is somewhat smaller than the translucent plate 2 so as to avoid an access to an end part 2a of the translucent plate 2 (refer to FIG. 3). A region for forming the anti-reflection part 3 will be described later in detail.

The substrate 30 is formed of resin such as triacetylcellulose (TAC), polyethylene terephthalate (PET), or polycarbonate (C). As a substrate 30, a material having a thickness of the order of 5 to 300 microns and superior optical characteristics is selected.

An irregular layer 31 is formed in the moth's eye structure, and is configured by a plurality of conical protrusions 31a being arrayed in a two-dimensional manner (along the rear face of the substrate 30) in array pitches, each of which is equal to or less than the wavelength of visible light.

Although the array pitch P of the conical protrusions 31a is not limited in particular as long as the pitch is equal to or less than the wavelength of visible light, these conical protrusions are formed so as to have an appropriate value according to the purpose because the wavelength dependency of reflectance is affected. The array pitch is set to the order of 100 nm, for example. The array pitch can be appropriately changed in the range of several tens of nm to several hundreds of nm. For example, height H is of the order of several hundreds of nm. A height H of a conical protrusion 31a influences wavelength dependency of reflectivity and thus is formed so as to have an appropriate value according to the purpose. For example, the height H is of the order of several hundreds of mm.

The term “conical” in the conical protrusion(s) 31A does not mean only a perfect cone or a truncated cone, it is sufficient if the shape is approximately a conical shape, and it is also sufficient if the shape is a tapered shape (sectional wedge shape). Also, a tip end part of a conical protrusion 31a may be a curved shape as shown in FIG. 2, and may not be sharpened up. In addition, the tip end part of the conical protrusion 31a can also be flattened. The conical protrusion 31a needs to be formed at least in the tapered shape in order to obtain the moth's eye structure, and the details in the structure can be appropriately changed according to the manufacturing constraint or purpose.

The anti-reflection part 3 is manufactured by forming, on the substrate 30, a resin layer having a photocurable property (such as a UV (Ultraviolet) property or an EB (Electron Beam photocurable property) and thereafter transferring the moth's eye shape by a stamper and further curing the resin layer by light irradiation to thereby form an irregular layer 31. It is preferable that the irregular layer 31 be formed having hydrophilicity as described later.

The anti-reflection part 3 utilizing the moth's eye structure is thus provided on the translucent plate 2, so that a refractive index can be varied as to the light incident from the outside of the gauge 100 and transmitted from the translucent plate 2 to an air layer between the translucent plate 2 and the display part 1 (it is possible to avoid generation of a discontinuous interface for the refractive index). Therefore, interfacial reflection of the incident light on the rear face of the translucent plate 2 is restrained, reflection of an external scene and solar light and illumination is reduced, and visibility of the display part 1 is improved. Also, in the translucent plate 2 on which the anti-reflection part 3 has been thus provided, transmissibility of the light that has been emitted from the display part 1 (the illumination light of the indicator 10 or the illumination light of the character plate 11) increases and thus there is no need to increase the light emission luminance of the light sources L1, L2 or the character plate light source L3, and power consumption of the gauge 100 can be restrained.

An AR (Anti-Reflective) coating may be applied to a front face of the translucent plate 2 so as to further obtain a reflection reduction effect. The AR coating is formed by a technique for vacuum vapor deposition such as magnesium fluoride, for example,

The casing 4 is formed of resin or metal or the like in a shape of a bottomed cylinder, and houses the display part 1. As shown in FIG. 3, at an open end of the casing 4, a flange 4a protruding in an outer diameter direction of the casing 4 is formed.

The facing member 5 is provided as an example of a defining member of the present invention, is formed of predetermined resin or the like in black for example, and is intended to cover an unrequired part inside the gauge 100. By the facing member 5, as shown in FIG. 3, a display region D1 of the display part 1 is defined. The facing member 5 is located between the display part 1 and the translucent plate 2, and is provided so as to surround an outer circumferential part of the display part 1.

The facing member 5, as shown in FIG. 3, has: a supporting part 50 that supports an end part 2a of the translucent plate 2; a diagonal fall part 51 that diagonally falls toward the display part 1; and a bent part 52 formed so as to be bent from the supporting part 50 and connecting the supporting part 50 and the diagonal fall part 51 to each other.

The supporting part 50 is a circumferential part which is supported by the flange 4a of the casing 4. At an upper end of the supporting part 50, a step difference 50a is formed to be aligned with the end part 2a of the translucent plate 2, and on the step difference 50a, the translucent plate 2 is placed.

The diagonal falling part 51 forms a shape of a conical cylinder. The diagonal falling part 51 diagonally falls toward the character plate 11 of the display part 1 through a bent part 52 from an upper end part of the supporting part 50. A tip end of the diagonal falling part 51 is located to be slightly spaced from the character plate 11, and does not abut against anything.

As shown in FIG. 3, the diagonal fall part 51 is located in a region D2 which is adjacent to the display region D1. Also, the bent part 52 is positioned in a region D3 which is adjacent to the region D2. In addition, the end part 2a of the translucent plate 2 to be clamped by a clamp part 8 which will be described later is located in a region D4 which is adjacent to the region D3. In summary, these regions are located in sequential order of the display region D1, the region D2, the region D3, and the region D4 from a center of the display part 1 toward an outer diameter direction.

The packing 6 is made of an elastic member (such as elastomer) which is formed in a shape of a circular ring so as to be taken along the end part 2a of the circular translucent plate 2. The packing 6, as shown in FIG. 3, forms a sectional substantial L-shape, and covers a front face of the end part 2a of the translucent plate 2 and a part of a side face.

In the present embodiment, the packing 6 and the facing member 5 constitute the clamp part 6 for clamping the end part 2a of the translucent plate 2. The clamp part 8, as described later, is swaged from the outer circumferential side by way of a bezel 7.

Although the clamp part 8 and the anti-reflection part 3 are mainly described with reference to FIG. 3, the clamp part 8 and the anti-reflection part 3 are formed so as to be approximately rotationally symmetrical to the vicinity of a center axle (the axle taken along a rotary shaft 14a) of the display part 1 and thus the shape in a case where the clamp part 8 and the anti-reflection part 3 are cut in an arbitrary cross section passing through the axle is approximately similar to the shape shown in FIG. 3.

Of the packing 6, at a part covering the front face of the end part 2a of the translucent plate 2, a rib 6a protruding toward the end part 2a is formed. If the clamp part 8 is swaged by the bezel 7, the translucent plate 2 is mainly clamped by the rib 6a and the supporting part 50 (step difference 50a). At the front side of the packing 6, a groove 6b is formed so as to correspond to the rib 6a. The groove 6b is provided to appropriately keep a pressure or the like applied from the packing 6 to the translucent plate 2 when the clamp part 8 is swaged.

Of the packing 6, a part covering a side ace of the end part 2a of the translucent plate 2 is a hanging part 6c that hangs toward a top face of the supporting part 50 of the facing member 5. If the clamp part 8 is swaged, the supporting part 50 and the hanging part 6c come into intimate contact with each other.

The bezel 7 is a frame member made of a metal for example, and as shown in FIG. 1, is formed in the shape a circular ring in a planar view. The bezel 7 is swaged and secured (swaging and securing) so as to clamp an open end (flange 4a) of the casing 4 and the clamp part 8 (facing member 5 and packing 6). In this manner, a force of clamping the translucent plate 2 by the clamp part 8 is applied and the clamp part 8 for clamping the translucent plate 2 is secured to the casing 4.

### (Region for Forming Anti-Reflection Part)

Hereinafter, with reference to FIG. 3, a region for forming the anti-reflection part 3 will be described.

In the gauge 100 of the present embodiment, the anti-reflection part 3 is provided so as to avoid an access to the end part 2a of the translucent plate 2 clamped by the clamp part 8, and is provided so as not to come into contact with the clamp part 8. Specifically, between an end face of the anti-reflection part 3 and the end part 2a of the translucent plate 2, an appropriate clearance (equivalent to a width of the region D3) is provided. By doing so, it is possible to prevent coming into contact with exterior parts, releasing, or entry of air bubbles into the anti-reflection part 3 owning to thermal expansion or the like.

Also, a tip end of the diagonal fall part 51 (the boundary between the display region D1 and the region D2) is located farther toward a central side of the display part 1 than a circumferential end of the anti-reflection part 3. According to this positional relationship, a circumferential end of the anti-reflection part 3 overlaps the facing member 5. Thus, it is possible to restrain the end face of the anti-reflection part 3 from being visually recognized in a linear shape through the translucent plate 2, and degradation of the appearance can be restrained.

In addition, when seen in the thickness direction of the gauge 100 (the vertical direction of FIG. 3), the boundary between the bent part 52 and the diagonal fall part 51 (the boundary between the region D3 and the region D2) is aligned with the circumferential end of the anti-reflection part 3. According to this positional relationship, corners of the bent part 52 and the diagonal fall part 51 are located immediately beneath the circumferential end of the anti-reflection part 3 and thus it is possible to more appropriately restrain the end face of the anti-reflection part 3 from being visually recognized in a linear shape through the translucent plate 2.

Further, when seen in the thickness direction of the gauge 100, an end at a front side of the bezel 7 is located farther toward a central side of the display part 1 than a circumferential end of the anti-reflection part 3. That is, the end (tip end) at the front side of the bezel 7 is located farther toward a side of the region D2 than the boundary between the region D3 and the region D2. By doing this, even if the display part 1 is seen at a somewhat diagonal angle, the end face of the anti-reflection part 3 is made inconspicuous and thus degradation of the appearance can be restrained more appropriately. The end at the front side of the bezel 7 may be at the same place as that of the circumferential end of the anti-translucent part 3.

It is preferable that the irregular layer 31 be formed having hydrophilicity to secure an anti-fog performance together with an anti-reflection performance exerted by the moth's eye structure. This is because owing to a synergetic effect between wettability exerted by being composed of hydrophilic resin and the moth's eye structure, even if the water made by agglutination of the moisture that is present in the gauge 100 is formed on the rear face of the translucent plate 2, fine water droplets are not obtained in particle size (several microns to several tens of microns) to an extent such that light is randomly reflected and it is possible to prevent a contact angle from being held in the state of an acute angle, and it is possible to prevent the layer from being visually recognized whitely as being cloudy. As a result, it is also possible to attain a certain dustproof effect to an extent such that coating of an anti-fog agent is unrequired. In order to attain such a dustproof effect together with the anti-fog effect, for example, it is sufficient if the irregular layer 31 is composed of a material containing hydrophilic polymer (such as protein or polyester amide) in UV curable resin or a material using an optical catalyst (titanium oxide) which exhibits hydrophilicity at the time of UV irradiation or the like.

Hereinafter, a gauge 200 according to a second embodiment, which is different from that of the first embodiment in configuration of the clamp part for clamping the translucent plate 2, will be mainly described with reference to FIG. 4. FIG. 4 is an enlarged view of a part equivalent to portion C shown in FIG. 1(b) in the gauge 200. Hereinafter, for the sake of a clear understanding of the configuration, constituent elements associated with the features of the second embodiment are designated by new reference numerals, and other constituent elements are designated by same reference numerals as those of the first embodiment, and further, the descriptive matters different from those of the first embodiment will be mainly described.

### Second Embodiment

In the gauge 200 according to the second embodiment, packing 206 and a facing member 205 constitute a clamp part 208 for clamping an end part 2a of a translucent plate 2. The clamp part 208 is swaged from the outer circumferential side by way of a bezel 7.

In the second embodiment, the facing member 205 does not abut against the translucent plate 2, and clamps the end part 2a of the translucent plate 2 via the packing 206. In the present specification, a configuration in which the facing member 205 works cooperatively with the packing 206 to indirectly clamp the translucent plate 2 is also included in an expression that the clamp part 208 clamps the translucent plate 2.

The packing 206 is made of an elastic member (such as elastomer) which is formed in a shape of a circular ring so as to be taken along the end part 2a of the circular translucent plate 2. The packing 206, unlike the first embodiment, forms a sectional U-shape, and covers the end part 2a of the translucent plate 2 so as to clamp it. In the packing 206 according to the second embodiment, a rib 6a and a groove 6 as in the first embodiment are not provided (however, they may be provided a required).

The facing member 205 is provided as an example of a defining member of the present embodiment, and defines a display region D1 of a display part 1. The facing member 205 has: a supporting part 250 that supports the packing 206 covering the end part 2a of the translucent plate 2; a diagonal fall part 251 that diagonally falls toward the display part 1; and a bent part 252 formed so as to be bent from the supporting part 250 and connecting the supporting part 250 and the diagonal fall part 251 to each other.

The supporting part 250 is a disk-shaped part which is supported by a flange 4a of a casing 4. The diagonal fall part 251, as in the first embodiment, forms the shape of a conical cylinder. The bent part 252 has a curved face and forms an R-shape and then connects the supporting part 250 and the diagonal fall part 251 to each other more smoothly than that of the first embodiment.

The diagonally falling part 251 is located in a region D2 which is adjacent to a display region D1. Also, the bent part 252 is located in a region D3 which is adjacent to the region D2. In addition, an end part 2a of a translucent plate 2 which is clamped by the clamp part 208 is located in a region D4 which is adjacent to the region D3.

A bezel 7 swages and secures an open end (flange 4a) of a casing 4 and the clamp part 208 (facing member 205 and packing 206) so as to clamp them. In this manner, a force of clamping the translucent plate 2 by the clamp part 208 is applied and the clamp part 208 for clamping the translucent plate 2 is secured to the casing 4.

### (Region for Forming Anti-Reflection Part)

In the gauge 200 of the second embodiment as well, an anti-reflection part 3 is provided to avoid an access to the end part 2a of the translucent plate 2 clamped by the clamp part 208, and is provided so as to not come into contact with the clamp part 208. Specifically, between an end face of the anti-reflection part 3 and the end part 2a of the translucent plate 2, an appropriate clearance (equivalent to a width of the region D3) is provided. Thus, as in the first embodiment, it is possible to prevent a release of the anti-reflection part 3 or entry of air bubbles into the anti-reflection part 3.

Also, a tip end of the diagonal fall part 251 (the boundary between the display region D1 and the region D2) is located farther toward a central side of the display part 1 than a circumferential end of the anti-reflection part 3. Thus, as in the first embodiment, it is possible to restrain the end face of the anti-reflection part 3 from being visually recognized in a linear shape through the translucent plate 2, and it is possible to restrain degradation of the appearance.

In addition, when seen in the thickness direction of the gauge 200, the boundary between the bent part 252 and the diagonal fall part 251 (the boundary between the region D3 and the region D2) is aligned with the circumferential end of the anti-reflection part 3. The boundary is equivalent to a part leading from the R-shaped bent part 252 to the diagonal fall part 251 that is approximately formed in a linear shape in a sectional view as shown in FIG. 4, in the front face of the bend part 252 and the diagonal fall part 251. According to this positional relationship as well, the boundary between the bent part 52 and the diagonally falling part 51 is located immediately beneath the circumferential end of the anti-reflection part 3 and thus it is possible to more appropriately restrain the end face of the anti-reflection part 3 from being visually recognized in a linear shape through the translucent plate 2.

In the second embodiment, when seen in the thickness direction of the gauge 200, the end at the front side of the bezel 7 is located farther toward the outer circumferential side than the circumferential end of the anti-reflection part 3. That is, this is a configuration which does not actively cover the end face of the anti-reflection part 3 with the bezel 7. Unlike the first embodiment, this configuration may be more acceptable.

In the configuration of the second embodiment as well, the end at the front side of the bezel 7 is located farther toward the central side of the display part 1 than the circumferential end of the anti-reflection part 3. Alternatively, by obtaining coincidence with the circumferential end of the anti-reflection part 3, the end face of the anti-reflection part 3 is made more inconspicuous, and degradation of the appearance may be restrained more appropriately.

The present invention is not limitative to the above embodiments and drawings. Appropriate modifications (including deletion of the constituent elements) can occur without departing from the spirit of the present invention.

### Modification Example

Although the foregoing descriptive matters were furnished as to examples in which the display part 1 is composed of an indicator-type gauge, the display part 1 that is visually recognized through the translucent plate 2 may be an image display device for displaying an image indicative of the amount of measurement. The image display device may be a liquid crystal display (LCD: Liquid Crystal Display) or an organic EL Electro-Luminescence) display or the like. Display of the amount of measurement by the image display device includes an aspect intended to cause a user to compare and read the measured values by displaying a bar graph or a guidance image as well as an aspect intended to specifically display the measured values by way of numeric values or characters.

Also, the shape of the translucent plate 2 and the anti-reflection part 3 is not limited to the circular shape. The shape may be an elliptical shape, a rectangular shape, a polygonal shape or the like.

Transportation means in which the gauges 100, 200 are incorporated are not limited to vehicles (including four-wheel motor vehicles, motor bicycles or the like). These gauges may be incorporated in other transportation means such as agricultural machines, ships, aircrafts, snow mobiles, or jet skis). In addition, the gauges 100, 200 may be air pressure gauges to be installed outside, for example, and may not be incorporated in transportation means.

In the following description, for the sake of a clear understanding of the present invention, a description of technical matters which are publicly known is appropriately omitted.

### INDUSTRIAL APPLICABILITY

The present invention is applicable to a gauge, and in particular is suitable for a gauge which is provided with an anti-reflection part having fine conical protrusions.

### DESCRIPTION OF REFERENCE NUMERALS

100, 200: Gauges
1: Display part
2: Translucent plate
2a: End part
3: Anti-reflection part
30: Substrate
31: Irregular layer
31a: Conical protrusion
4: Casing
4a: Flange
5, 205: Facing members (example of defining member)
50, 250: Supporting parts
51, 251: Diagonal fall parts
52, 252: Bent parts
6, 206: Packings
7: Bezel
8, 208: Clamp parts

1. A gauge comprising:
a display part that displays an amount of measurement;
a translucent plate located at a front side of the display part and causing visual recognition through the display part;
a clamp part that clamps an end part of the translucent plate; and
an anti-reflection part provided on a face at a side of the display part of the translucent plate and having a plurality of conical protrusions arrayed in pitches, each of which is equal to or less than a wavelength of visible light,
wherein the anti-reflection part is provided at a position not in the end part and not in contact with the clamp part.

2. The gauge according to claim 1, comprising a defining member located between the display part and the translucent plate to surround an outer circumferential part of the display part and configured to define a display region of the display part,
wherein the defining member has a diagonal falling part that diagonally falls toward the display part, and
a tip end of the diagonal fall part is located farther toward a central side of the display part than a circumferential end of the anti-reflection part.

3. The gauge according to claim 2, wherein the defining member has:
a supporting part that supports the end part of the translucent plate; and
a bent part formed so as to be bent from the supporting part and connecting the supporting part and the diagonal fall part to each other,
wherein a boundary between the bent part and the diagonal fall part is aligned with the circumferential end of the anti-reflection part when seen in a thickness direction of the gauge.

4. The gauge according to claim 2, wherein the clamp part is formed at least by an elastic member that covers a front face of the end part and the defining member.

5. The gauge according to claim 1, comprising:
a casing that houses the display part; and
a bezel for clamping and securing an open end of the casing and the clamp part,
wherein an end of a front side of the bezel is at the same place as that of a circumferential end of the anti-reflection part or is located farther toward the central side of the display part than the circumferential end of the anti-reflection part when seen in the thickness direction of the gauge.

6. The gauge according to claim 3, wherein the clamp part is formed at least by an elastic member that covers a front face of the end part and the defining member.
